(19) United States
(12) Patent Application Publication
(10) Pub. No.: US 2016/0344009 A1
(43) Pub. Date: Nov. 24, 2016

(54) COATING LIQUID AND LAMINATED POROUS FILM

(71) Applicant: SUMITOMO CHEMICAL COMPANY, LIMITED, Chuo-ku, Tokyo (JP)

(72) Inventors: Junji SUZUKI, Niihama-shi (JP); Kenichiro SUGAWARA, Niihama-shi (JP); Masateru SEMBARA, Niihama-shi (JP)

(73) Assignee: SUMITOMO CHEMICAL COMPANY, LIMITED, Chuo-ku, Tokyo (JP)

(21) Appl. No.: 14/383,636

(22) PCT Filed: Jan. 27, 2014
(86) PCT No.: PCT/JP2014/052369

§ 371 Date: Sep. 8, 2014

(51) Int. Cl. H01M 2/16; C09D 101/10

(52) U.S. Cl. CPC H01M 2/1686; H01M 2/1653; H01M 2/166; C09D 101/10; C08K 3/22

(57) ABSTRACT

The present invention relates to a laminated porous film having a heat-resistant layer that is suitable for a separator for a non-aqueous electrolyte secondary battery having excellent cycle characteristics, and a coating liquid for forming the heat-resistant layer. A coating liquid containing a filler, a binder, and a solvent, wherein hydrophilicity parameter A of the filler defined by formula (1) is 0.35 to 0.65:

Hydrophilicity parameter A=BET₁/BET₂ (1)
wherein
BET₁: the specific surface area of the filler calculated using a BET method from a differential adsorption isotherm obtained by subtracting, from a first adsorption isotherm measured by adsorbing water vapor to the filler, a second adsorption isotherm; and
BET₂: the specific surface area of the filler calculated using a BET method from a differential adsorption isotherm measured by adsorbing nitrogen to the filler.

### TECHNICAL FIELD

The present invention relates to a coating liquid and a laminated porous film.

### BACKGROUND ART

A non-aqueous electrolyte secondary battery, particularly a lithium ion secondary battery, is widely used as a battery used for a personal computer, a mobile phone, and a personal digital assistance because the battery has a high energy density.

The non-aqueous electrolyte secondary battery typified by the lithium ion secondary battery has a high energy density. Therefore, when internal short-circuit or external short-circuit is caused by damage of the battery or damage of a device including the battery, a large current flows through the battery and thus the battery vigorously generates heat.

As a result, a function to prevent heat generation above a certain level is required of the non-aqueous electrolyte secondary battery. As a non-aqueous electrolyte secondary battery having such a function, a battery including a separator having a shutdown function has been known. The shutdown function is a function of shutting down passage of ions between a positive electrode and a negative electrode by the separator at the time of abnormal heat generation. This function prevents further heat generation.

Examples of the separator having the shutdown function include a porous film made of a material that melts at the time of abnormal heat generation. A battery having the separator can shut down the ion passage and suppress further heat generation since the porous film is molten at the time of abnormal heat generation to be turned into a non-porous film.

As such a separator having a shutdown function, for example, a porous film containing a polyolefin as a main component is used. The separator made of the polyolefin porous film suppresses further heat generation by melting at about 80 to 180° C. at the time of abnormal heat generation of the battery to be turned into a non-porous film, and thus shutting down the ion passage. However, when vigorous heat generation occurs, the battery may cause short-circuit due to direct contact between the positive electrode and the negative electrode by shrinkage or breakage of the separator made of the polyolefin porous film. As described above, the separator made of the polyolefin porous film has insufficient shape stability and may not suppress abnormal heat generation due to the short-circuit.

Some separators for a non-aqueous electrolyte secondary battery having excellent shape stability at high temperatures have been proposed. As one of them, a separator for a non-aqueous electrolyte secondary battery made of a laminated porous film formed by laminating a heat-resistant layer containing a particulate filler and a porous film containing a polyolefin as a main component onto each other has been proposed (for example, refer to Patent Document 1).

### PRIOR ART DOCUMENTS

### Patent Documents

Patent Document 1: JP-A-2004-227972

### DISCLOSURE OF THE INVENTION

However, improvement of cycle characteristics is required of the non-aqueous electrolyte secondary battery described in Patent Document 1.

Under such circumstance, an object of the present invention is to provide a non-aqueous electrolyte secondary battery having excellent cycle characteristics, a laminated porous film having a heat-resistant layer suitable for a separator for the secondary battery, and a coating liquid for forming the heat-resistant layer.

Accordingly, the present invention relates to the following aspects.

<1> A coating liquid containing a filler, a binder, and a solvent, wherein hydrophilicity parameter A of the filler defined by formula (1) is 0.35 to 0.65:

Hydrophilicity parameter A=BET₁/BET₂ (1)

wherein

BET₁: the specific surface area of the filler calculated using a BET method from a differential adsorption isotherm obtained by subtracting, from a first adsorption isotherm measured by adsorbing water vapor to the filler, a second adsorption isotherm; and

BET₂: the specific surface area of the filler calculated using a BET method from a differential adsorption isotherm measured by adsorbing nitrogen to the filler.

<2> The coating liquid according to <1>, wherein the filler is made of an inorganic oxide.

<3> The coating liquid according to <2>, wherein the inorganic oxide is α-alumina.

<4> The coating liquid according to <1>, wherein the binder is a water-soluble polymer.

<5> The coating liquid according to <1>, wherein the binder is one or more selected from carboxymethyl cellulose, alkyl cellulose, hydroxyalkyl cellulose, starch, polyvinyl alcohol, acrylic acid, and alginic acid.

<6> The coating liquid according to <1>, containing 100 parts by weight or more and 10000 parts by weight or less of the filler to 100 parts by weight of the binder.

<7> The coating liquid according to <1>, wherein the solvent is a protic solvent.

<8> The coating liquid according to <1>, wherein the solvent is one or more selected from water, ethanol, isopropanol, 1-propanol, and t-butyl alcohol.

<9> A laminated porous film including a polyolefin base porous film and a heat-resistant layer made of a porous layer containing a filler and a binder laminated onto each other, wherein hydrophilicity parameter A of the filler defined by formula (1) is 0.35 to 0.65:

Hydrophilicity parameter A=BET₁/BET₂ (1)

wherein

BET₁: the specific surface area of the filler calculated using a BET method from a differential adsorption isotherm obtained by subtracting, from a first adsorption isotherm measured by adsorbing water vapor to the filler, a second adsorption isotherm; and

BET₂: the specific surface area of the filler calculated using a BET method from a differential adsorption isotherm measured by adsorbing nitrogen to the filler.

<10> A non-aqueous electrolyte secondary battery including the laminated porous film as described in <9>.

### MODE FOR CARRYING OUT THE INVENTION

The laminated porous film of the present invention is a porous film including a polyolefin base porous film (hereinafter may be referred to as an “A layer”) and a heat-resistant layer (hereinafter may be referred to as a “B layer”) made of a porous layer containing a binder and a filler laminated onto each other. Here, the A layer provides a shutdown function to the laminated porous film by melting the porous film to be turned into a non-porous film when the battery vigorously generates heat. The B layer has heat resistance at a high temperature at which shutdown occurs and thus the laminated porous film having the B layer has shape stability even at a high temperature.

The laminated porous film may include three or more layers of the A layer and the B layer as long as the layers are laminated in sequence. For example, the B layers may be formed on both sides of the A layer.

The laminated porous film is produced by a method including the steps of applying a coating liquid containing a filler, a binder, and a solvent which will be described later to one side or both sides of the A layer to form a coating film and removing the solvent from the coating film.

First, the coating liquid of the present invention used for forming the heat-resistant layer will be described.

(Coating Liquid)

The coating liquid of the present invention is a coating liquid containing a filler, a binder, and a solvent, wherein hydrophilicity parameter A of the filler defined by formula (1) is 0.35 to 0.65:

Hydrophilicity parameter A=BET₁/BET₂ (1)

wherein

BET₁: the specific surface area of the filler calculated using a BET method from a differential adsorption isotherm obtained by subtracting, from a first adsorption isotherm measured by adsorbing water vapor to the filler, a second adsorption isotherm; and

BET₂: the specific surface area of the filler calculated using a BET method from a differential adsorption isotherm measured by adsorbing nitrogen to the filler.

BET₁ is a value reflecting the chemical adsorption amount of water to the filler. Specifically, the filler is made to adsorb water vapor by feeding water vapor to the filler at a predetermined temperature with the partial pressure of water vapor being changed. The first adsorption isotherm is obtained by measuring the adsorption amount of water vapor to the filler during this operation. Subsequently, an operation in which the adsorbed water is desorbed from the filler is carried out. Then, the measurement container containing the filler is degassed. The filler is made to adsorb water vapor by feeding water vapor to the filler again with the partial pressure of water vapor being changed. The second adsorption isotherm is obtained by measuring the second adsorption amount of water vapor to the filler.

The first adsorption isotherm is thought to reflect both the physical adsorption amount and the chemical adsorption amount of water to the filler and the second adsorption isotherm is thought to reflect the physical adsorption amount of water to the filler. Therefore, the differential adsorption isotherm obtained by subtracting the second adsorption isotherm from the first adsorption isotherm is thought to reflect the chemical adsorption amount of water to the filler.

BET₂ is the specific surface area of the filler. Specifically, the filler is made to adsorb nitrogen by feeding nitrogen to the filler at a predetermined temperature with the partial pressure of nitrogen being changed. The adsorption isotherm is obtained by measuring the adsorption amount of nitrogen to the filler during this operation.

By dividing BET₁ by BET₂, a value reflecting the chemical adsorption amount of water per unit specific surface area of the filler is obtained.

A larger value of hydrophilicity parameter A represents higher hydrophilicity of the filler surface.

Hydrophilicity parameter A of the filler contained in the coating liquid is 0.35 or more and 0.65 or less, and preferably 0.36 or more and 0.60 or less.

A specific evaluation procedure (BET measurement method) of hydrophilicity parameter A will be described in detail in Examples taking a case where the evaluation target filler is alumina particles as an example.

As the filler, an organic filler, an inorganic filler, and a mixture thereof can be used. A plurality of fillers may be used.

Examples of the organic filler include particulates made of polymers obtained by polymerizing one or more monomers selected from the group consisting of ethylene, propylene, styrene, vinyl ketone, acrylonitrile, methyl methacrylate, ethyl methacrylate, glycidyl methacrylate, glycidyl acrylate, methyl acrylate, melamine, urea, formaldehyde, tetrafluoroethylene, tetrafluoroethylene, hexafluoropropylene, and vinylidene fluoride.

Examples of the inorganic filler include particulates made of calcium carbonate, talc, clay, kaolin, silica, hydrotalcite, diatomaceous earth, magnesium carbonate, barium carbonate, calcium sulfate, magnesium sulfate, barium sulfate, aluminum hydroxide, magnesium hydroxide, calcium oxide, magnesium oxide, titanium oxide, alumina, mica, zeolite, and glass.

Among them, an inorganic oxide is more preferable, and alumina which has high chemical stability is particularly preferable from the viewpoint of, for example, chemical stability, and shape stability at high temperatures.

Among aluminas, α-alumina which is in a high temperature stable phase and has thermal and chemical stability is most preferable.

The coating liquid of the present invention is produced by a method including the steps of preparing a slurry (1) having a filler concentration of 5% to 50% by mixing a protic solvent with a filler having a median diameter of 1 to 10 μm (hereinafter may be referred to as a slurry preparation step); producing a slurry (2) by wet milling the slurry (1) under conditions of a liquid temperature of 0 to 50° C. and a residence time of 1 to 30 minutes with a bead mill filled with 75 to 90% of beads having an average particle diameter of 0.1 to 2.0 mm (hereinafter may be referred to as a wet milling step); and mixing the slurry (2) with a binder (hereinafter may be referred to as a coating liquid production step).

The median diameter (D50) of the raw material filler is 1 to 10 μm, and preferably 3 to 9 μm.

In the slurry preparation step, a protic solvent is used. Examples of the protic solvent include water, ethanol, isopropanol, 1-propanol, t-butyl alcohol, and mixtures thereof. From the viewpoint of processes and environmental load, water is preferably used.

The protic solvent is mixed with the raw material filler by a known method to prepare the slurry (1) having a filler concentration of 5% to 50% (% by weight). The filler concentration of the slurry (1) is preferably 10 to 40% by weight.

Subsequently, the slurry (2) is produced by wet milling the slurry (1) under conditions of a liquid temperature of 0 to 50° C. and a residence time of 1 to 30 minutes with a bead mill filled with 75 to 90% of beads having an average particle diameter of 0.1 to 2.0 mm. In the wet milling step, a bead mill (DYNO-Mill) having high grinding performance and hydrophilization performance is used.

The average particle diameter of the beads is preferably 0.5 to 1.5 mm. The beads are preferably formed from zirconia, alumina, glass, titania, or silicon nitride. Zirconia and alumina are preferable because they have excellent grinding performance and abrasion resistance and are difficult to cause contamination.

In a pass method, the residence time can be obtained by the following formula.

Residence time(pass method) (min)=[Vessel volume (L)−Bead filling volume (L)+Bead gap volume (L)]/Flow rate (L/min)

The circumferential velocity of a disk during the wet milling is preferably 1 m/sec to 30 m/sec.

A value obtained by dividing the median diameter (D50) of the filler contained in the slurry (2) by the median diameter (D50) of the raw material filler is preferably in a range of 0.05 to 0.15.

The slurry (2) obtained by the above-described method is mixed with the binder to produce a coating liquid.

Specifically, the coating liquid is obtained by mixing with and dispersing in the slurry (2) a liquid containing the binder dissolved or swelled in a solvent or an emulsified liquid of a resin until the liquid becomes homogeneous. For example, conventionally known devices such as a three-one motor, a homogenizer, a media type dispersing device, and a pressure type dispersing device are used to mix the slurry (2) with the binder.

The solvent used during the coating liquid production step may be the same solvent as used in the slurry preparation step. From the viewpoint of processes and environmental load, a solvent containing water as a main component is preferably used. Use of a mixed solvent obtained by mixing water with an organic solvent such as methanol, ethanol, isopropanol, 1-propanol, t-butyl alcohol, acetone, or N-methylpyrrolidone is preferable because a coating liquid that is easy to be applied to the polyolefin base porous film is obtained. Particularly, a mixed solvent of water and an alcohol is preferable. Among the alcohols, ethanol, isopropanol, and 1-propanol, which have a relatively low boiling point and are easily handled, are more preferable.

As the binder, a material that binds the filler to each other, binds to the polyolefin base porous film, and is dissolved or dispersed in the solvent is used. A water-soluble polymer is preferably used for the binder because a water-based coating liquid can be produced.

As the binder, a water-soluble polymer having a hydrophilic functional group is preferable. Examples of the water-soluble polymer include carboxymethyl cellulose, alkyl cellulose, hydroxyalkyl cellulose, starch, polyvinyl alcohol, acrylic acid, and alginic acid. A salt of carboxymethyl cellulose may be used as carboxymethyl cellulose. Specific examples of the salt of carboxymethyl cellulose include a metal salt of carboxymethyl cellulose. The metal salt of carboxymethyl cellulose is preferable because it is excellent in shape retainability upon heating. Particularly, sodium carboxymethyl cellulose is more preferable because it is commonly used and easily available. A salt of acrylic acid may be used as acrylic acid. Examples of acrylic acid include a metal salt of acrylic acid, and sodium acrylate is particularly preferable. A metal salt of alginic acid may be used as alginic acid. Examples of alginic acid include metal salts of alginic acid, and sodium alginate is particularly preferable. Two or more materials may also be used as the binder.

A binder having an adequate molecular weight may be selected so that the coating liquid may have a viscosity suitable for coating.

In the coating liquid production step, the binder is mixed with the slurry (2) containing the filler so that preferably 100 to 10000 parts by weight, and more preferably 1000 to 5000 parts by weight of the filler is contained to 100 parts by weight of the binder. By forming the heat-resistant layer from the thus obtained coating liquid, a laminated porous film having an excellent balance between ion permeability and difficulty in dust fall is obtained. The dust fall is a phenomenon in which the filler falls off from the laminated porous film.

The solid concentration of the coating liquid is preferably 5 to 55% by weight and more preferably 10 to 50% by weight.

A surfactant, a pH adjuster, a dispersing agent, a plasticizer, and the like can be added to the coating liquid as long as the object of the present invention is not impaired.

The laminated porous film is produced by a method including the steps of applying the coating liquid to one side or both sides of the A layer to forma coating film and removing the solvent from the coating film.

(Polyolefin Base Porous Film (A Layer))

The A layer is made of a polyolefin. It is preferable that the A layer contains a high molecular weight component having a weight average molecular weight of 5×10⁵ to 15×10⁶. Examples of the polyolefin include polymers obtained by homopolymerizing or copolymerizing olefin monomers such as ethylene, propylene, 1-butene, 4-methyl-1-pentene, and 1-hexene. A high molecular weight polyethylene mainly composed of a constitutional unit derived from ethylene is preferable.

The porosity of the A layer is preferably 20 to 80% by volume and further preferably 30 to 70% by volume. When the porosity is less than 20% by volume, the retention amount of an electrolytic solution may be small, while when the porosity exceeds 80% by volume, the porous film insufficiently turns into a non-porous film at high temperatures at which shutdown occurs. In other words, the current may not be shut down when the battery vigorously generates heat.

The thickness of the A layer is usually 4 to 50 μm and preferably 5 to 30 μm. When the thickness is less than 4 μm, shutdown may be insufficient, while when the thickness exceeds 50 μm, the thickness of the laminated porous film increases and thus the electric capacity of the battery may be small.

The pore diameter of the A layer is preferably 3 μm or less and more preferably 1 μm or less.

The A layer has a large number of pores through which gases and liquids can permeate from one side to the other side of the A layer. The permeation ratio is usually represented as a Gurley value. The Gurley value of the laminated porous film of the present invention is preferably in a range of 30 to 400 sec/100 cc, and preferably in a range of 50 to 300 sec/100 cc.

A method for producing the A layer is not particularly limited. Examples of the method include a method in which a plasticizer is added to a thermoplastic resin to form a film and thereafter the plasticizer is removed with a suitable solvent as described in JP-A-7-29563 and a method in which a film made of a thermoplastic resin produced by a known method is prepared and fine pores are formed by selectively stretching amorphous parts of the film which are structurally weak as described in JP-A-7-304110. For example, when the A layer is formed from a polyolefin resin containing an ultra-high molecular weight polyethylene and a low molecular weight polyolefin having a weight average molecular weight of 10000 or less, the A layer is preferably produced by the following method from the viewpoint of production cost.

The method is a method including the steps of (1) kneading 100 parts by weight of an ultra-high molecular weight polyethylene, 5 to 200 parts by weight of a low molecular weight polyolefin having a weight average molecular weight of 10000 or less, and 100 to 400 parts by weight of an inorganic filler such as calcium carbonate to obtain a polyolefin resin composition;

(2) forming a sheet by using the polyolefin resin composition;

(3) removing the inorganic filler from the sheet obtained in step (2); and

(4) stretching the sheet obtained in step (3) to obtain the A layer.

(Production of Laminated Porous Film)

As long as wet coating can be carried out uniformly, the method for applying the coating liquid to the A layer is not particularly limited and conventionally known methods can be employed. For example, a capillary coating method, a spin coating method, a slit die coating method, a spray coating method, a dip coating method, a roll coating method, a screen printing method, a flexographic printing method, a bar coating method, a gravure coating method, and a die coating method can be employed. The thickness of the B layer can be controlled by adjusting the thickness of the coating film, the solid concentration that is represented by the sum of the binder concentration and the filler concentration in the coating liquid, and the ratio of the filler to the binder.

When the coating liquid is applied to the A layer, a film made of a resin, a belt made of a metal, or a drum can be used as a supporting member that fixes or carries the A layer.

For the A layer, it is preferable that a hydrophilization treatment is carried out before the application of the coating liquid. When a coating liquid having a high water concentration is applied, it is particularly preferable that the hydrophilization treatment is carried out on the A layer in advance. Examples of the hydrophilization treatment include a chemical treatment using an acid or an alkali, a corona treatment, and a plasma treatment.

In the corona treatment, the A layer can be hydrophilized in a relatively short time and, in addition, modification of the polyolefin resin by the corona discharge is limited to near the surface of the A layer. As a result, the corona treatment has an advantage of ensuring high coatability because it does not change properties inside the A layer. Therefore, the corona treatment is preferable.

As the method for removing the solvent from the coating film, a method by drying is usually used. As a drying temperature of the solvent, a temperature at which the air permeability of the A layer is not deteriorated is preferable, and the temperature is usually 10 to 120° C. and preferably 20 to 80° C.

Through the steps described above, a heat-resistant layer (B layer) is formed on the A layer.

The thickness of the B layer is usually in a range of 0.1 μm or more and 20 μm or less and preferably in a range of 1 μm or more and 15 μm or less. When the thickness is too large, the thickness of the laminated porous film increases and thus the electric capacity of the battery may be small. When the thickness is too small, the laminated porous film may shrink because the laminated porous film cannot resist heat shrinkage of the A layer at the time of vigorous heat generation of the battery.

When the B layers are formed on both sides of the A layer, the thickness of the B layers is the total thickness of the two B layers.

The B layer is a porous layer formed by linking the filler with the binder. The B layer has a large number of pores that can permeate gases and liquids from one surface to the other surface of the B layer and are formed by linking voids of the fillers to each other.

The pore diameter of the pores is preferably 3 μm or less and further preferably 1 μm or less. The pore diameter of the pores means an average value of diameters of spheres that are obtained by approximating the pores to a spherical shape. When the pore diameter exceeds 3 μm, the battery may easily cause short-circuit when a carbon powder that is a main component of the positive electrode or the negative electrode or small pieces of the electrodes drop off.

The porosity of the B layer is preferably 30 to 90% by volume and more preferably 35 to 85% by volume.

(Laminated Porous Film)

The laminated porous film of the present invention is obtained by the method described above using the coating liquid of the present invention. The laminated porous film of the present invention is a laminated porous film including the polyolefin base porous film and the heat-resistant layer containing the filler and the binder laminated onto each other, wherein hydrophilicity parameter A of the filler defined by formula (1) is 0.35 to 0.65:

Hydrophilicity parameter A=BET₁/BET₂ (1)

wherein

BET₁: the specific surface area of the filler calculated using a BET method from a differential adsorption isotherm obtained by subtracting, from a first adsorption isotherm measured by adsorbing water vapor to the filler, a second adsorption isotherm; and

BET₂: the specific surface area of the filler calculated using a BET method from a differential adsorption isotherm measured by adsorbing nitrogen to the filler.

The thickness of the laminated porous film of the present invention is usually 5 to 80 μm, preferably 5 to 50 μm, and particularly preferably 6 to 35 μm. When the thickness of the laminated porous film is less than 5 μm the film is easy to break, while when the thickness exceeds 80 μm, the electric capacity of the battery may be small.

The porosity of the laminated porous film of the present invention is usually 30 to 85% and preferably 40 to 80%.

The air permeability of the laminated porous film of the present invention is preferably 50 to 2000 sec/100 cc, more preferably 50 to 1000 sec/100 cc, and further preferably 50 to 300 sec/100 cc. When the air permeability exceeds 2000 sec/100 cc, ion permeability of the laminated porous film and load characteristics of the battery may deteriorate.

For the dimension retention ratio of the laminated porous film at high temperatures at which shutdown occurs, both the dimension retention ratio in an MD direction and the dimension retention ratio in a TD direction of the A layer are preferably 85% or more, more preferably 90% or more, and further preferably 95% or more. The MD direction means the length direction when the A layer is produced and the TD direction means the width direction when the A layer is produced. When the dimension retention ratio is less than 85%, the battery may cause short-circuit between the positive electrode and the negative electrode by heat shrinkage of the laminated porous film at high temperatures at which shutdown occurs. As a result, the shutdown function may be insufficient. The high temperature at which shutdown occurs is a temperature of 80 to 180° C. It is preferable that the dimension retention ratio at 130 to 160° C. satisfies the conditions described above.

The laminated porous film of the present invention can include porous films such as an adhesion film and a protection film other than the A layer and the B layer as long as the object of the present invention is not impaired.

The laminated porous film of the present invention is suitable for the separator for batteries, particularly non-aqueous electrolyte secondary batteries. The non-aqueous electrolyte secondary battery including the laminated porous film of the present invention has excellent cycle characteristics. The non-aqueous electrolyte secondary battery has high safety because the separator shuts down even when the battery vigorously generates heat.

In addition, the non-aqueous electrolyte secondary battery of the present invention is expected to have excellent safety properties such as overcharge properties, nail penetration properties, and impact resistance, and excellent battery properties such as load characteristics.

### EXAMPLES

Hereinafter, the present invention will be specifically described with reference to examples. However, the present invention is not limited to these examples.

In the examples and comparative examples, physical properties of the laminated porous film were measured by the following methods.

(1) Thickness Measurement (Unit: μm):

The thickness of the laminated porous film was measured by a high precision digital measuring instrument manufactured by Mitutoyo Corporation.

(2) Film Weight (Unit: g/m²):

A square having a length of 8 cm on a side was cut from the laminated porous film. The weight W (g) of the sample was measured.

The film weight was calculated by the following formula: Film weight (g/m²)=W/(0.08×0.08). The film weight of the B layer was calculated by subtracting the film weight of the A layer from the film weight of the laminated porous film that was similarly measured.

(3) Particle Diameter (Median Diameter, D50)

The particle diameter was measured with MICROTRAC (MODEL: MT-3300EXII) manufactured by NIKKISO CO., LTD.

(4) Air Permeability:

According to JIS P8117, the air permeability was measured with a digital timer type Gurley type densometer manufactured by Toyo Seiki Seisaku-sho, Ltd.

(5) Water Vapor Adsorption

<Apparatus>

Measurement apparatus: BELSORP-aquaIII (manufactured by BEL Japan, Inc.)

Pretreatment apparatus: BELPREP-vacII (manufactured by BEL Japan, Inc.)

<Pretreatment Method>

Vacuum degassing was carried out for a filler placed in a glass tube at 200° C. for 8 hours.

<Measurement Conditions>

Adsorption temperature: 298.15 K

Saturated vapor pressure: 3.169 kPa

Adsorbate cross-sectional area: 0.125 nm²

Adsorbate: Pure water

Molecular weight of water: 18.020

Equilibrium waiting time: 500 sec* * Waiting time after reaching an adsorption equilibrium state (a state in which pressure change at the time of adsorption and desorption is equal to or less than a predetermined value)

<Measurement Method>

An adsorption isotherm of water vapor was measured by using a constant volume method. Into the glass tube containing the pretreated filler, water vapor was fed at the adsorption temperature with increasing the relative pressure of water vapor until the relative pressure of water vapor reached about 0.3. The adsorption amount of water vapor to the filler was measured with feeding water vapor to obtain a first adsorption isotherm. Subsequently, the adsorption amount of water vapor to the filler was measured with reducing the relative pressure of water vapor in the glass tube until the relative pressure of water vapor reached about 0.1.

Subsequently, degassing of the filler was carried out in the measurement apparatus at the adsorption temperature for 2 hours.

A second adsorption isotherm of the filler was obtained by carrying out the same operation as the operation in the measurement of the first adsorption isotherm.

<Analysis Method>

A differential adsorption isotherm was obtained by subtracting the second adsorption isotherm from the first adsorption isotherm. The specific surface area (BET₁) of the filler was calculated from the differential adsorption isotherm by a BET method (a multipoint method, seven points in the range of a relative pressure of about 0.1 to about 0.3).

(6) Nitrogen Adsorption

<Apparatus>

Measurement apparatus: BELSORP-mini (manufactured by BEL Japan, Inc.)

Measurement apparatus: BELPREP-vacll (manufactured by BEL Japan, Inc.)

<Pretreatment Method>

Vacuum degassing was carried out for a filler placed in a glass tube at 200° C. for 8 hours.

<Measurement Conditions>

Adsorption temperature: 77 K

Adsorbate: Nitrogen

Saturated vapor pressure: Measured

Adsorbate cross-sectional area: 0.162 nm²

Equilibrium waiting time: 500 sec* * Waiting time after reaching an adsorption equilibrium state (a state in which pressure change at the time of adsorption and desorption is equal to or less than a predetermined value)

<Measurement Method>

An adsorption isotherm of nitrogen was measured by using a constant volume method. Into the glass tube containing the pretreated filler, nitrogen was fed at the adsorption temperature with increasing the relative pressure of nitrogen until the relative pressure of nitrogen reached about 0.5. The adsorption amount of nitrogen to the filler was measured with feeding nitrogen. An adsorption isotherm was obtained from the adsorption amount of nitrogen to the filler measured in the operation during which the relative pressure of nitrogen was increased, and the relative pressure of nitrogen.

<Analysis Method>

The specific surface area (BET₂) of the filler was calculated from the adsorption isotherm of nitrogen by a BET method (a multipoint method, five points in the range of a relative pressure of about 0.1 to about 0.2).

Blinders and fillers used in the A layer and the B layer are as follows.

<A Layer>

Polyethylene-Based Porous Film

To a total amount of 100 parts by weight of an ultra-high molecular weight polyethylene and a polyethylene wax obtained by mixing 70% by weight of an ultra-high molecular weight polyethylene powder (340M, manufactured by Mitsui Chemicals, Inc.) with 30% by weight of a polyethylene wax having a weight average molecular weight of 1000 (FNP-0115, manufactured by NIPPON SEIRO CO., LTD.), 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added, and calcium carbonate having an average diameter of 0.1 μm (manufactured by MARUO CALCIUM CO., LTD.) was further added so that its volume was 38% by volume to the total volume. These materials were mixed with a Henschel mixer in the form of powder and thereafter the mixed material was melt-kneaded with a twin-screw kneading machine to obtain a polyolefin resin composition. The polyolefin resin composition was rolled with a pair of rolls having a surface temperature of 150° C. to form a sheet. Calcium carbonate was dissolved and removed by immersing the sheet in an aqueous hydrochloric acid solution (hydrochloric acid 4 mol/L, nonionic surfactant 0.5% by weight), and subsequently, the sheet was stretched to six times at 105° C. to obtain a polyolefin base porous film.

### [Polyolefin Base Porous Film]

Film thickness: 17.1 to 17.3 μm

Film weight: 7.1 to 7.2 g/m²

<B Layer>

### [Binder]

Sodium carboxymethyl cellulose (CMC): CMC1110 manufactured by Daicel Corporation

### [Filler 1]

α-alumina: CA-30M manufactured by Sumitomo Chemical Co., Ltd. (median diameter (D50)=6.50 μm)

### [Filler 2]

α-alumina: AKP3000 manufactured by Sumitomo Chemical Co., Ltd. (median diameter (D50)=0.61 μm)

### Example 1

### (1) Production of Slurry

A slurry in Example 1 was prepared by the following procedure.

To stirred water, a filler 1 was added so that the alumina concentration was 30.0% by weight to obtain a slurry (1). Subsequently, the slurry (1) was wet milled by a pass method using DYNO-Mill (type KDL-PILOT A) manufactured by AG MASCHINENFABRIK, BASEL under wet milling conditions (dish circumferential velocity: 10 m/sec, bead material: ZrO₂, bead diameter: 1.0 mm, bead filling rate: 85% by volume (to the vessel volume of DYNO-Mill), flow rate: 0.5 L/min, residence time: 2.9 min, and slurry temperature: 20° C. to 40° C.) to obtain a slurry (2). The median diameter (D50) of alumina in the slurry (2) was 0.66 μm. Subsequently, the slurry (2) was dried to obtain a powder. An adsorption isotherm of the powder was measured and analyzed. Hydrophilicity parameter A of the powder was 0.37 (BET₁=2.0 m²/g, BET₂=5.4 m²/g).

### (2) Production of Coating Liquid

The slurry (2), CMC, and a solvent (water and isopropyl alcohol) were mixed so that the amount of CMC was 3 pars by weight to 100 parts by weight of alumina, the solid concentration (CMC+alumina) was 27.7% by weight of a solid content, and the solvent composition was 95% by weight of water and 5% by weight of isopropyl alcohol to obtain a mixed liquid. A coating liquid (1) was produced by treating the mixed liquid using a high-pressure dispersing device (manufactured by Sugino Machine Limited, “Star Burst”) under a high pressure dispersion condition (100 MPa×3 passes).

### (3) Production and Physical Property Evaluation of Laminated Porous Film

A corona treatment was carried out to one side of the A layer at 20 W/(m²/min). Subsequently, onto the side of the A layer subjected to the corona treatment, the coating liquid (1) was applied using a gravure coater to form a coating film. By drying the coating film, a laminated porous film (1) including the A layer and the B layer laminated on one side of the A layer was obtained.

Physical properties of the laminated porous film (1) are shown in Table 1.

### (4) Cycle Characteristics Evaluation

<Preparation of Positive Electrode>

As a positive electrode active material, LiNi_{1/3}Mn_{1/3}Co_{1/3}O₂ was used. First, 90 parts by weight of the positive electrode active material, 6 parts by weight of acetylene black, and 4 parts by weight of polyvinylidene fluoride (manufactured by KUREHA CORPORATION) were mixed to obtain a mixture. The mixture was dispersed in N-methyl-2-pyrrolidone to obtain a slurry for the positive electrode. The slurry for the positive electrode was uniformly applied onto an aluminum foil that is a positive electrode collector and dried. The obtained laminated body was flatted to a thickness of 80 μm with a pressing machine. A sample having a size of 30 mm×45 mm was cut out from the flatted laminated body so that the sample included 13 mm of a part to which the slurry for the positive electrode was not applied (hereinafter may be referred to as an uncoated part). The sample was used as the positive electrode. The density of the positive electrode active material layer in the positive electrode was 2.30 g/cm³.

<Preparation of Negative Electrode>

As a negative electrode active material, a graphite powder was used. To 98 parts by weight of the graphite powder, 100 parts by weight of an aqueous carboxymethyl cellulose solution (the concentration of sodium carboxymethyl cellulose was 1% by weight) and 1 part by weight of a water emulsion of styrene-butadiene rubber as a thickener and a binder were added to obtain a slurry for the negative electrode. The slurry for the negative electrode was applied onto a rolled copper foil having a thickness of 20 μm that is a negative electrode collector and dried. The obtained laminated body was flatted to a thickness of 80 μm with a pressing machine. A sample having a size of 35 mm×50 mm was cut out from the flatted laminated body so that the sample included 13 mm of a part to which the slurry for the negative electrode was not applied (hereinafter may be referred to as an uncoated part). The sample was used as the negative electrode. The density of the negative electrode active material layer in the negative electrode was 1.40 g/cm³.

<Electrolytic Solution>

As an electrolytic solution, 1 M LiPF₆-EC (ethylene carbonate)-EMC (ethylmethyl carbonate)-DEC (diethyl carbonate) (EC:EMC:DEC was 3:5:2 in volume ratio) was used.

<Preparation of Battery>

Between the positive electrode and the negative electrode, in each of which a nickel tab was attached to each uncoated part, the laminated porous film (1) was placed so that the B layer of the laminated porous film (1) was in contact with the positive electrode. A laminated body formed by laminating the positive electrode, the laminated porous film (1), and the negative electrode in this order was placed in an aluminum-made bag made by laminating an aluminum layer onto a heat-sealing layer, and 1.00 cc of the electrolytic solution was further added into the bag. The aluminum-made bag was heat-sealed with reducing pressure to obtain a battery.

<Cycle Test>

To a new battery which has not been subjected to a charge/discharge cycle, four-cycle initial charge/discharge was carried out at 25° C. in a voltage range of 4.1 to 2.7 V at a current value of 0.2 C (a current value at which a rated capacity defined by a 1-hour discharge capacity is discharged over 1 hour is determined as 1 C, and the same applies hereafter).

Subsequently, 100 cycles of charge/discharge were carried out at 25° C. in a voltage range of 4.2 to 2.7 Vat a constant current of a current value of 1.0 C.

The discharge capacity retention rate after 100 cycles (Discharge capacity at 100th cycle/first discharge capacity after initial charge/discharge×100) is shown in Table 2.

### Example 2

### (1) Production of Slurry

A slurry (3) having a median diameter (950) of 0.43 and hydrophilicity parameter A of 0.49 (BET₁=3.5 m²/g, BET₂=7.2 m²/g) and containing alumina was obtained by a similar manner to the production method of the slurry (2) in Example 1 except that the residence time was set to 8.00 min.

### (2) Production of Coating Liquid

A coating liquid (2) was obtained by an operation similar to that in Example 1 except that the slurry (3) was used.

### (3) Production and Physical Property Evaluation of Laminated Porous Film

A laminated porous film (2) was obtained by an operation similar to that in Example 1 except that the coating liquid 2 was used.

Physical properties of the laminated porous film (2) are shown in Table 1.

### (4) Cycle Characteristics Evaluation

Cycle characteristics were evaluated in a similar manner to Example 1 except that the laminated porous film (2) was used. The result is shown in Table 2.

### Comparative Example 1

### (1) Filler

As the filler, a filler 2 (BET₁=1.5 m²/g, BET₂=4.7 m²/g, hydrophilicity parameter A=0.32) was used.

### (2) Production of Coating Liquid

AKP3000, CMC, and a solvent (water and isopropyl alcohol) were mixed so that the amount of CMC was 3 pars by weight to 100 parts by weight of alumina, the solid concentration (CMC+alumina) was 27.7% by weight, and the solvent composition was 95% by weight of water and 5% by weight of isopropyl alcohol to obtain a mixed liquid. A coating liquid (3) was produced by treating the mixed liquid using a high-pressure dispersing device (manufactured by Sugino Machine Limited, “Star Burst”) under a high pressure dispersion condition (100 MPa×3 passes).

### (3) Production and Physical Property Evaluation of Laminated Porous Film

A corona treatment was carried out to one side of the A layer at 20 W/(m²/min). Subsequently, onto the side of the A layer subjected to the corona treatment, the coating liquid (3) was applied using a gravure coater to form a coating film. By drying the coating film, a laminated porous film (3) including the A layer and the B layer laminated on one side of the A layer was obtained. Physical properties of the laminated porous film (3) are shown in Table 1.

### (4) Cycle Characteristics Evaluation

Cycle characteristics were evaluated in a similar manner to Examples 1 and 2 except that the laminated porous film (3) was used. The result is shown in Table 2.

### Reference Example 1

A slurry (4) was obtained by a similar manner to the production method of the slurry (2) in Example 1 except that the residence time was set to 12.0 min. The median diameter (D50) of alumina in the slurry (4) was 0.41 μm. Subsequently, the slurry (4) was dried to obtain a powder. An adsorption isotherm of the powder was measured and hydrophilicity parameter A was calculated. As a result, it was 0.57 (BET₁=4.4 m²/g, BET₂=7.7 m²/g). The result is shown in Table 3.

### Reference Example 2

A slurry (5) was obtained by a similar manner to the production method of the slurry (2) in Example 1 except that the residence time was set to 16.0 min. The median diameter (D50) of alumina in the slurry (5) was 0.39 μm. Subsequently, the slurry (5) was dried to obtain a powder. An adsorption isotherm of the powder was measured and hydrophilicity parameter A was calculated. As a result, it was 0.63 (BET₁=5.6 m²/g, BET₂=8.9 m²/g). The result is shown in Table 3.

### Reference Example 3

A slurry (6) was obtained by a similar manner to the production method of the slurry (2) in Example 1 except that the residence time was set to 20.0 min. The median diameter (D50) of alumina in the slurry (6) was 0.38 μm. Subsequently, the slurry (6) was dried to obtain a powder. An adsorption isotherm of the powder was measured and hydrophilicity parameter A was calculated. As a result, it was 0.63 (BET₁=6.4 m²/g, BET₂=10.1 m²/g). The result is shown in Table 3.

TABLE 1

| | Unit | | | | | | |
|---|---|---|---|---|---|---|---|
| | Total film | A layer film | B layer film | Total film | A layer film | B layer film | Air |
| | thickness | thickness | thickness | weight | weight | weight | permeability |
| | μm | μm | μm | g/m² | g/m² | g/m² | sec/100 mL |
| Example 1 | 21.6 | 17.1 | 4.5 | 14.9 | 7.1 | 7.8 | 112 |
| Example 2 | 20.8 | 17.3 | 3.5 | 14.5 | 7.2 | 7.3 | 115 |
| Comparative | 21.6 | 17.3 | 4.3 | 13.8 | 7.1 | 6.7 | 111 |
| Example | | | | | | | |

TABLE 2

| | Discharge |
|---|---|
| | capacity |
| | retention rate |
| | % |
| Example 1 | 80 |
| Example 2 | 75 |
| Comparative | 73 |
| Example | |

TABLE 3

| | Wet | | | | |
|---|---|---|---|---|---|
| | milling | Median | | | |
| | residence | diameter | | | |
| | time | (D50) | BET₁ | BET₂ | Parameter |
| Unit | min | μm | m²/g | m²/g | A |
| Example 1 | 2.9 | 0.66 | 2.0 | 5.4 | 0.37 |
| Example 2 | 8.0 | 0.43 | 3.5 | 7.2 | 0.49 |
| Reference | 12.0 | 0.41 | 4.4 | 7.7 | 0.57 |
| Example 1 | | | | | |
| Reference | 16.0 | 0.39 | 5.6 | 8.9 | 0.63 |
| Example 2 | | | | | |
| Reference | 20.0 | 0.38 | 6.4 | 10.1 | 0.63 |
| Example 3 | | | | | |
| Comparative | — | 0.61 | 1.5 | 4.7 | 0.32 |
| Example | | | | | |

Example 1 and Example 2 showed better discharge capacity retention rates than the comparative example.

The reason why the discharge capacity retention rates are improved is considered as follows. It is assumed that, when the hydrophilicity parameter of the filler is in the range of 0.35 to 0.65, shortage of an electrolytic solution during the cycle can be prevented by improving wettability of the filler to the electrolytic solution and thus the discharge capacity retention rate is improved. In contrast, when the hydrophilicity parameter is higher than 0.65, it is presumed that thermal and electrochemical stability of the filler surface is deteriorated and thus the discharge capacity retention rate is deteriorated.

### INDUSTRIAL APPLICABILITY

According to the present invention, a laminated porous film having a heat-resistant layer suitable for a separator for a non-aqueous electrolyte secondary battery having excellent cycle characteristics, and a coating liquid for forming the heat-resistant layer can be obtained.

1. A coating liquid comprising a filler, a binder, and a solvent, wherein hydrophilicity parameter A of the filler defined by formula (1) is 0.35 to 0.65:
Hydrophilicity parameter A=BET₁/BET₂ (1)
wherein
BET₁: the specific surface area of the filler calculated using a BET method from a differential adsorption isotherm obtained by subtracting, from a first adsorption isotherm measured by adsorbing water vapor to the filler, a second adsorption isotherm; and
BET₂: the specific surface area of the filler calculated using a BET method from a differential adsorption isotherm measured by adsorbing nitrogen to the filler.

2. The coating liquid according to claim 1, wherein the filler is made of an inorganic oxide.

3. The coating liquid according to claim 2, wherein the inorganic oxide is α-alumina.

4. The coating liquid according to claim 1, wherein the binder is a water-soluble polymer.

5. The coating liquid according to claim 1, wherein the binder is one or more selected from carboxymethyl cellulose, alkyl cellulose, hydroxyalkyl cellulose, starch, polyvinyl alcohol, acrylic acid, and alginic acid.

6. The coating liquid according to claim 1, comprising 100 parts by weight or more and 10000 parts by weight or less of the filler to 100 parts by weight of the binder.

7. The coating liquid according to claim 1, wherein the solvent is a protic solvent.

8. The coating liquid according to claim 1, wherein the solvent is one or more selected from water, ethanol, isopropanol, 1-propanol, and t-butyl alcohol.

9. A laminated porous film comprising a polyolefin base porous film and a heat-resistant layer made of a porous layer containing a filler and a binder laminated onto each other, wherein hydrophilicity parameter A of the filler defined by formula (1) is 0.35 to 0.65:
Hydrophilicity parameter A=BET₁/BET₂ (1)
wherein
BET₁: the specific surface area of the filler calculated using a BET method from a differential adsorption isotherm obtained by subtracting, from a first adsorption isotherm measured by adsorbing water vapor to the filler, a second adsorption isotherm; and
BET₂: the specific surface area of the filler calculated using a BET method from a differential adsorption isotherm measured by adsorbing nitrogen to the filler.

10. A non-aqueous electrolyte secondary battery comprising the laminated porous film as claimed in claim 9.
